(19) United States
(12) Patent Application Publication
(10) Pub. No.: US 2012/0153162 A1
(43) Pub. Date: Jun. 21, 2012

(54) HIGH PERFORMANCE STRADDLE CARRIER CBRNE RADIATION VERIFICATION SYSTEM

(75) Inventor: David L. Frank, Boca Raton, FL (US)

(73) Assignee: Innovative American Technology Inc., Coconut Creek, FL (US)

(21) Appl. No.: 12/501,220

(22) Filed: Jul. 10, 2009

Related U.S. Application Data
(63) Continuation-in-part of application No. 12/409,758, filed on Mar. 24, 2009.
Application No. 12/409,758 is a continuation-in-part of application No. 12/468,382, filed on May 19, 2009.
Application No. 12/468,382 is a continuation-in-part of application No. 12/468,334, filed on May 19, 2009, now Pat. No. 7,994,482.
Application No. 12/468,334 is a continuation-in-part of application No. 11/564,193, filed on Nov. 28, 2006, now Pat. No. 7,851,766.
Application No. 11/564,193 is a continuation-in-part of application No. 11/291,574, filed on Dec. 1, 2005, now Pat. No. 7,592,601.
Application No. 11/291,574 is a continuation-in-part of application No. 10/280,255, filed on Oct. 25, 2002, now Pat. No. 7,005,982.
(60) Provisional application No. 61/134,405, filed on Jul. 10, 2008.
(60) Provisional application No. 61/183,185, filed on Jun. 2, 2009.
(60) Provisional application No. 61/070,560, filed on Mar. 24, 2008.
(60) Provisional application No. 61/128,115, filed on May 19, 2008.
(60) Provisional application No. 61/128,114, filed on May 19, 2008.
(60) Provisional application No. 60/347,997, filed on Oct. 26, 2001.

(51) Int. Cl. G01T 7/00

(52) U.S. Cl. 250/360.1

(57) ABSTRACT

A hazardous materials detection and identification system includes a set of distributed sensors across one or more sides of a self propelled frame structure such as a straddle carrier or similar cargo equipment device. The system non-invasively analyzes vehicles, one or more containers in a stack, a container during lift and movement, a package, cargo, or other objects, that are located in an analysis position relative to the self propelled frame structure for detection and identification of hazardous materials such as chemicals, biological materials, radiological materials, fissile materials, and explosives (CBRNE). The system includes one or more detector arrays that can be configured for various applications such as: shipping container inspection, seaport security, cargo terminal security, airport vehicle inspection, airport cargo inspection, airport baggage inspection, vehicle inspection, truck stop cargo inspection, border protection inspecting vehicles, cargo, persons, railway inspections, railcar inspection, and subway security.

### CROSS-REFERENCE TO RELATED APPLICATIONS

This application is based on, and claims priority from, co-pending U.S. Provisional Patent Application No. 61/134,405, filed on Jul. 10, 2008, by inventor David L. FRANK, and entitled “High Performance Straddle Carrier CBRNE Radiation Verification System”; and also claims priority from co-pending U.S. Provisional Patent Application No. 61/183,185, filed on Jun. 1, 2009, by inventor David L. FRANK, and entitled “High Performance Straddle Carrier CBRNE Verification System”; and further is based on and claims priority to co-pending U.S. patent application Ser. No. 12/409,758, entitled “Horizontal Sensor Arrays For Non-Invasive Identification Of Hazardous Materials”, filed on Mar. 24, 2009, which is based on and claims priority to prior co-pending provisional U.S. Patent Application No. 61/070,560, entitled “Horizontal Sensor Arrays For Non-Invasive Analysis Of CBRNE Materials Present”, filed on Mar. 24, 2008, by the same inventor; and this application further is based on and claims priority to co-pending U.S. patent application Ser. No. 12/468,382, entitled “Mobile Frame Structure With Passive/Active Sensor Arrays For Non-Invasive Identification Of Hazardous Materials”, filed on May 19, 2009, which is based on and claims priority to prior co-pending provisional U.S. Patent Application No. 61/128,115, entitled “Mobile Frame Structure With Passive/Active Sensor Arrays For Non-Invasive Analysis For CBRNE Materials Present”, filed on May 19, 2008, by the same inventor; and this application further is based on and claims priority to co-pending U.S. patent application Ser. No. 12/468,334, entitled “Radiation Directional Finder And Isotope Identification System”, filed on May 19, 2009, which is based on and claims priority to prior co-pending provisional U.S. Patent Application No. 61/128,114, entitled “Radiation Directional Finder and Isotope Identification System”, filed on May 19, 2008, by the same inventor; and this application further is a continuation-in-part of and claims priority from, co-pending U.S. patent application Ser. No. 11/564,193 entitled “Multi-Stage System for Verification of Container Contents”, filed on Nov. 28, 2006, which is a continuation-in-part of, and claims priority from, prior co-pending U.S. patent application Ser. No. 11/291,574, filed on Dec. 1, 2005, which is a continuation-in-part of, and claims priority from, prior co-pending U.S. patent application Ser. No. 10/280,255, filed on Oct. 25, 2002, now U.S. Pat. No. 7,005,982 issued on Feb. 28, 2006, and that was based on prior U.S. Provisional Patent Application No. 60/347,997, filed on Oct. 26, 2001, now expired; the collective entire disclosure of which being herein incorporated by reference.

### FIELD OF THE INVENTION

The present invention generally relates to mobile frame structures with sensors for detection and identification of hazardous materials, and more particularly relates to a straddle carrier or other self-propelled frame structure with sensors for non-invasive detection of hazardous materials such as chemicals, biological materials, radiological materials, fissile materials, and explosives (CBRNE) in containers.

### BACKGROUND OF THE INVENTION

Current designs for radiation detection systems deployed on mobile frame structures such as straddle carriers simply install collimated gamma and neutron detectors in a column on both sides of the straddle carrier. This design is extremely costly and inefficient with heavy materials used for collimation and large straddle carrier frames required to support the weight. The costs of such systems are prohibitive for volume procurement and deployment. The recent concerns over the smuggling of radiological materials to enable a dirty bomb or even an atomic bomb for use by terrorists creates a strong need for a cost effective solution for radiation detection systems deployed on mobile frame structures such as straddle carriers to enable more effective defense systems at borders, stations, and ports.

Therefore, a need exists to overcome the problems with the prior art as discussed above.

### SUMMARY OF THE INVENTION

A high performance design for a straddle carrier, according to one embodiment of the present invention, provides detection and identification of radiation sources such as radioactive materials, gamma radiation emitting materials, and fissile materials. This embodiment of the present invention enables an efficient sensor configuration for a high sensor performance capability with moderate costs. The straddle carrier radiation verification system (SCRVS) provides highly accurate and sensitive non-invasive scanning of containers that are stacked 1, 2, 3 or 4 containers high in multiple columns and/or the scanning of a container during movement.

For container scanning, the SCRVS deploys radiation sensors deployed on both sides of a straddle carrier to form a target zone. Sensor-detector mounting panels are installed to form a wall on each side of the straddle carrier, from the bottom of the straddle carrier to the top of the straddle carrier. The panels are designed to be one container high. Currently shipping containers are approximately nine feet high. According to one embodiment, gamma sensors are deployed on the inside of these panels and neutron detectors are deployed on the outside of the panels. However, other arrangements of any combination of gamma sensors, neutron sensors, or both, may be deployed on the straddle carrier according to various applications.

Sodium Iodide (NaI) or similar gamma detectors, according to one embodiment, are deployed on the straddle carrier for scanning container stacks. Up to about 20 2×4×16 NaI sensors are configured on the inside of each panel. These sensors are used to enable scanning of the detectors in the stack with the straddle carrier moving at speeds of up to about three kilometers per hour.

The NaI detectors are deployed in pairs to provide directional indication of the radiation source materials detected. Such a radiation directional finder system is described in U.S. patent application Ser. No. 12/468,334, entitled “Radiation Directional Finder And Isotope Identification System”, the entire teachings of which being incorporated herein by reference. Such radiation directional finders enable the SCRVS to determine which container in the stack contains the detected radiological material(s). Gamma detector data is provided to a spectral analysis system that utilizes a detection process to detect the presence of radiological materials and to determine the container that holds such materials. The spectral analysis system, according to one embodiment, utilizes software algorithms to analyze radiation data collected from sensors to determine if a specific isotope can be identified.

Plastic scintillation detectors, for example, are used for neutron detection, such as described in U.S. patent application Ser. No. 12/483,066, entitled “High Performance Neutron Detector with Near Zero Gamma Cross Talk”, the entire teachings of which being incorporated herein by reference. The neutron detectors are deployed, in this example, on the back side of each panel. The neutron detectors utilize collimators to assist in the directional indication of fissile source material(s). The neutron detector data is provided to the spectral analysis system to detect the presence of fissile materials and to determine the container that holds such materials.

A gross count of gamma detection across the container is used to map the container being scanned and to illustrate the gross gamma detection collected across the container.

The SCRVS identifies the specific container(s) where the radiological or fissile materials are detected. The container(s) is/are then noted for secondary scanning.

The secondary scanning device, according to one embodiment, comprises a group of one or more high resolution sensor devices such as germanium detectors. The germanium detectors are provided with cryocooler support to reduce the operational temperature to a desired level. The high resolution sensors are mounted on an elevator. The elevator raises or lowers the high resolution sensors to the desired container position for secondary analysis. The SCRVS then moves to scan the targeted container at speeds of up to about 1.5 kph and provides detector data to the spectral analysis system for isotope identification.

The use of an elevator system for the high resolution sensors reduces the need to deploy a large number of these costly sensors where they are needed. In other words, the use of the elevator system allows a concentrated number of high resolution sensors to be moved into position to perform a high speed and highly accurate analysis of an individual targeted container position in a stack of containers in a very cost effective manner.

To perform container inspection during container movement, according to one embodiment, the straddle carrier includes a spreader bar that is equipped with gamma and neutron sensors across the top of the container. In addition to the spreader bar mounted sensors, horizontal sensor rails can be mounted on the sides of the straddle carrier, shuttle carrier, or cargo movement device, that extend out to place gamma and or neutron detectors along the bottom portion of the container. This sensor arrangement provides a multi-sided array of sensors to scan the container to enable greater sensitivity.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a top view of an example of a self propelled frame structure with various sensors scanning one or more containers in a stack, according to one embodiment of the present invention.

FIG. 2 is a block diagram illustrating a second example of a self propelled frame structure with various sensors scanning one or more containers in a stack, according to one embodiment of the present invention.

FIG. 3 is a block diagram illustrating an example of a hazardous materials detection and identification system, according to one embodiment of the present invention.

FIG. 4 a perspective view of an example of a straddle carrier comprising one or more sensor arrays for detection and identification of hazardous materials, according to one embodiment of the present invention.

FIGS. 5 and 6 are schematic diagrams illustrating side views of the straddle carrier shown in FIG. 4.

FIGS. 7 and 8 are side views of a gamma scanning sensor array panel, according to one embodiment of the present invention.

FIG. 9 is a side view of multiple gamma scanning sensor array panels, according to one embodiment of the present invention.

FIGS. 10 and 11 are side views of a neutron scanning sensor array panel, according to one embodiment of the present invention.

FIG. 12 is a side view of multiple neutron scanning sensor array panels, according to one embodiment of the present invention.

FIG. 13 is a side view of a gamma sensor array elevator arrangement, according to one embodiment of the present invention.

FIG. 14 is a side view of a gamma sensor array with a sensor interface unit, according to one embodiment of the present invention.

FIG. 15 is a block diagram illustrating an example of a source location process, according to one embodiment of the present invention.

FIG. 16 is a side view of an example of a directional detector set, according to one embodiment of the present invention.

FIG. 17 is a graph showing test results for directional indication using a directional detector set, according to one embodiment of the present invention.

FIG. 18 is a side view of an example of a horizontal sensor rail and further showing the sensor rail in an extended position and in a retracted position, according to one embodiment of the present invention.

FIG. 19 is a side perspective view of an example of a straddle carrier with sensor arrays on a spreader bar and on one or more horizontal sensor rails, according to one embodiment of the present invention.

### DETAILED DESCRIPTION

As required, detailed embodiments of the present invention are disclosed herein. However, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure and function. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The terms “program”, “computer program”, “software application”, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

A data storage means, as defined herein, includes many different types of computer readable media that allow a computer to read data therefrom and that maintain the data stored for the computer to be able to read the data again. Such data storage means can include, for example, non-volatile memory, such as ROM, Flash memory, battery backed-up RAM, Disk drive memory, CD-ROM, DVD, and other permanent storage media. However, even volatile storage such as RAM, buffers, cache memory, and network circuits are contemplated to serve as such data storage means according to different embodiments of the present invention.

Various embodiments of the present invention overcome problems with the prior art by providing a distributed array of sensors including one or more horizontal arrays allowing a brief stop of a vehicle or container for analysis. The various embodiments provide for (1) an ability to scan the contents of a vehicle/container as it enters and exits a detection zone, (2) a fixed geometry between each sensor array in the distributed array of sensors and the target materials when the vehicle/container is stopped, (3) an ability to analyze the vehicle or container within seconds from a single position, and (4) adequate spectral data acquisition within seconds enabling identification of CBRNE materials.

One embodiment of the invention includes gamma and neutron sensors that can be deployed in a distributed sensor network around a target area (or detection zone) and configured as an array for vehicle/container analysis. The gamma and neutron sensors are deployed on both sides of the detection area and in multiple positions on each side to provide adequate coverage of the full vehicle/container lengths. The sensors can be configured as one or more horizontal arrays positioned, for example, along a centerline of a container to be inspected to minimize the number of sensors required and to optimize data acquisition times.

The sensors are connected via one or more Sensor Integration Units (SIU's) that provide the calibration, automated gain control, calibration verification, remote diagnostics, and connectivity to the processor for spectral analysis of the sensor data. One example of such an SIU is described in U.S. Pat. No. 7,269,527 entitled “System Integration Module for CBRNE Sensors”, which is herein incorporated by reference.

The sensors may also be shielded from electro-magnetic-interference (EMI). A data collection system, electrically coupled with each sensor device, collects signals from the sensor devices. The collected signals represent whether each sensor device has detected gamma or neutron radiation. Optionally, a remote monitoring system is communicatively coupled with the data collection system to remotely monitor the collected signals from the sensor devices and thereby remotely determine whether one or more gamma/neutron sensor devices from the array have provided gamma radiation data or neutron radiation data, and a spectral analysis system identifies the specific isotopes detected by the sensors, as will be more fully discussed below. A user interface provides sensor related data, such as a graphic presentation of the data from each sensor and group of sensors, the detection of radiation, and the identification of the one or more isotopes detected by the sensors.

Described now is an example of a Straddle Carrier Radiation Verification System (SCRVS) for radiation detection and isotope identification and the operation of the same, according to various embodiments of the present invention.

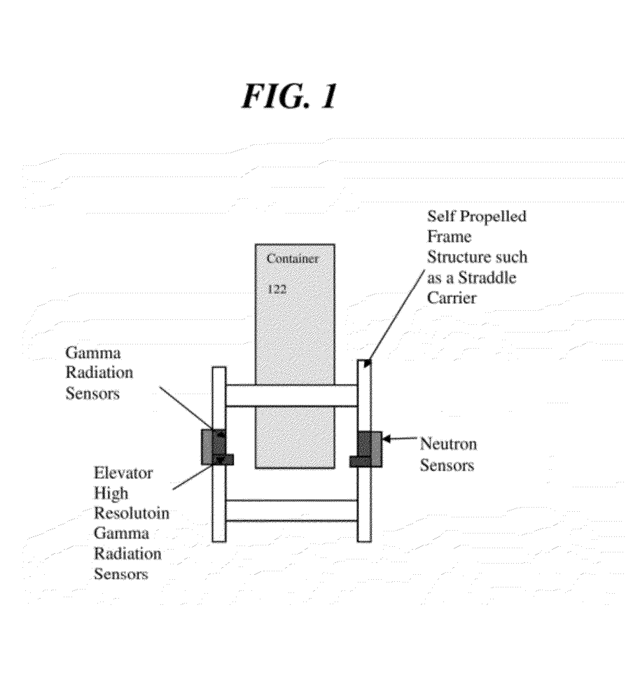

FIG. 1 shows an example of a sensor deployment for scanning analysis of vehicles and cargo containers using a self propelled frame structure that moves across a container or vehicle under inspection. This arrangement provides significantly improved efficiency and deployment capabilities over conventional detector systems. Gamma radiation sensors and neutron radiation sensors are deployed on the frame structure as shown. One or more high resolution sensor devices such as germanium detectors are mounted on an elevator to move the high resolution sensors into a detection position to perform a high speed and highly accurate analysis of an individual targeted container position in a stack of containers in a very cost effective manner.

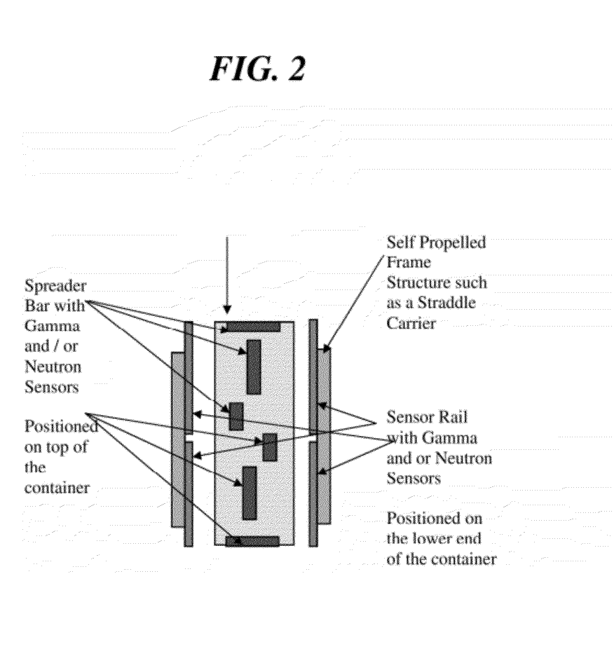

FIG. 2 illustrates one example of a sensor deployment for verification of cargo contents where a self propelled frame structure such as a straddle carrier or shuttle carrier or forklift lifts and carries one or more containers. The one or more containers are lifted using a spreader bar component of the straddle carrier and that includes gamma and/or neutron sensors strategically positioned on top of the container while being lifted by the spreader bar. Additionally, one or more sensor rails, as shown mounted on the sides of the straddle carrier, include gamma and/or neutron sensors positioned about the lower end of the container. This sensor arrangement provides a multi-sided array of sensors to scan the container to enable greater sensor sensitivity.

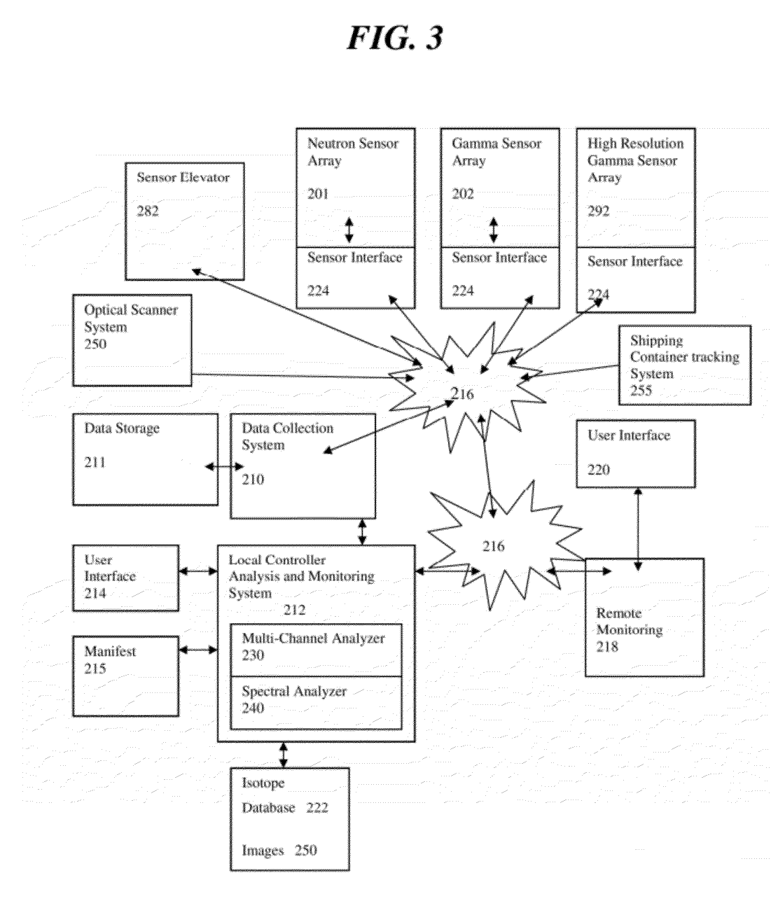

With reference to FIG. 3, a data collection system 210, in this example, is communicatively coupled via cabling, wireless communication link, and/or other communication link 216 with each of the gamma radiation sensor devices 202, 292 and neutron sensor devices 201 via one or more sensor interface units 224. The high resolution sensors are moved up and down the frame for optimum positions by the elevator and elevator control 282. Optionally, a micro-neutron pulse can be added any of the one or more gamma and or neutron detectors 201, 202, 292, to enable the identification of materials, and/or to enable the identification of shielded fissile materials within a detection area. The data collection system 210 includes an information processing system that communicates via data communication interfaces with the sensor interface units 224 that collect signals from the radiation sensor units 201, 202, 292. The collected signals, in this example, represent detailed spectral data from each sensor device that has detected radiation.

The data collection system 210 is modular in design and can be used specifically for radiation detection and identification, or for data collection for various types of hazardous materials sensors such as for explosives and special materials detection and identification.

The data collection system 210 is communicatively coupled with a local controller and monitor system 212. The local system 212 comprises an information processing system that includes a computer, memory, storage, and a user interface 214 such as a display on a monitor and a keyboard, or other user input/output device. In this example, the local system 212 also includes a multi-channel analyzer 230 and a spectral analyzer 240.

The multi-channel analyzer (MCA) 230 comprises a device composed of many single channel analyzers (SCA). The single channel analyzer interrogates analog signals received from the individual radiation sensors-detectors 201, 202, 292, and determines whether the specific energy range of the received signal is equal to the range identified by the single channel. If the energy received is within the SCA the SCA counter is updated. Over time, the SCA counts are accumulated. At a specific time interval, the multi-channel analyzer 230 includes a number of SCA counts, which result in the creation of a histogram. The histogram represents a spectral image of the radiation that is present at the radiation sensors 201, 202, 292. The MCA 230, according to one example, uses analog to digital converters combined with computer memory that is equivalent to thousands of SCAs and counters and is dramatically more powerful and cheaper.

The histogram is used by the spectral analysis system 240 to identify isotopes that are present in materials contained in the container under examination. One of the functions performed by the information processing system 212 is spectral analysis, performed by the spectral analyzer 240, to identify the one or more isotopes, explosives or special materials contained in a container under examination. With respect to radiation detection, the spectral analyzer 240 compares one or more spectral images of the radiation present to known isotopes that are represented by one or more spectral images 250 stored in the isotope database 222. By capturing multiple variations of spectral data for each isotope there are numerous images that can be compared to one or more spectral images of the radiation present. The isotope database 222 holds the one or more spectral images 250 of each isotope to be identified. These multiple spectral images represent various levels of acquisition of spectral radiation data so isotopes can be compared and identified using various amounts of spectral data available from the one or more sensors. Whether there are small amounts (or large amounts) of data acquired from the sensor, the spectral analysis system 240 compares the acquired radiation data from the sensor to one or more spectral images 250 for each isotope to be identified. This significantly enhances the reliability and efficiency of matching acquired spectral image data from the sensor to spectral image data of each possible isotope to be identified. Once the one or more possible isotopes are determined present in the radiation detected by the sensor(s), the information processing system 212 can compare the isotope mix against possible materials, goods, and/or products, that may be present in the container under examination. Additionally, a manifest database 215 includes a detailed description of the contents of each container that is to be examined. The manifest 215 can be referred to by the information processing system 212 to determine whether the possible materials, goods, and/or products, contained in the container match the expected authorized materials, goods, and/or products, described in the manifest for the particular container under examination. This matching process, according to an embodiment of the present invention, is significantly more efficient and reliable than any container contents monitoring process in the past.

The spectral analysis system 240, according to an embodiment, includes an information processing system and software that analyzes the data collected and identifies the isotopes that are present. The spectral analysis software, in this example, consists of more that one method to provide multi-confirmation of the isotopes identified. Should more than one isotope be present, the system identifies the ratio of each isotope present. Examples of methods that can be used for spectral analysis such as in the spectral analysis software according to an embodiment of a container contents verification system, include: 1) a margin setting method as described in U.S. Pat. No. 6,847,731; and 2) a LINSCAN method (a linear analysis of spectra method) as described in U.S. Provisional Patent Application No. 11/624,067, filed on Jan. 17, 2006, by inventor David L. Frank, and entitled “Method For Determination Of Constituents Present From Radiation Spectra And, If Available, Neutron And Alpha Occurrences”; the collective entire teachings of which being herein incorporated by reference.

With respect to analysis of collected data pertaining to explosives and/or special materials, the spectral analyzer 240 and the information processing system 212 compare identified possible explosives and/or special materials to the manifest 215 by converting the stored manifest data relating to the shipping container under examination to expected explosives and/or radiological materials and then by comparing the identified possible explosives and/or special materials with the expected explosives and/or radiological materials. If the system determines that there is no match to the manifest for the container then the identified possible explosives and/or special materials are unauthorized. The system can then provide information to system supervisory personnel to alert them to the alarm condition and to take appropriate action.

The user interface 214, for example, can present to a user a representation of the collected received returning signals, or the identified possible explosives and/or special materials in the shipping container under examination, or any system identified unauthorized explosives and/or special materials contained within the shipping container under examination, or any combination thereof.

The data collection system can also be communicatively coupled with a remote control and monitoring system 218 such as via a network 216. The remote system 218 comprises an information processing system that has a computer, memory, storage, and a user interface 220 such as a display on a monitor and a keyboard, or other user input/output device. The network 216 comprises any number of local area networks and/or wide area networks. It can include wired and/or wireless communication networks. This network communication technology is well known in the art. The user interface 220 allows remotely located service or supervisory personnel to operate the local system 212 and to monitor the status of shipping container verification by the collection of sensor units 201, 202 and 292 deployed on the frame structure. An optical scanner system 250 can be remotely operated and allows the remotely located service or supervisory personnel to view an operating environment where the sensors 201, 202, 292, are scanning a container or other object under inspection. Additionally, a shipping container tracking system 255 tracks each shipping container and provides container identification information to the local control system 212.

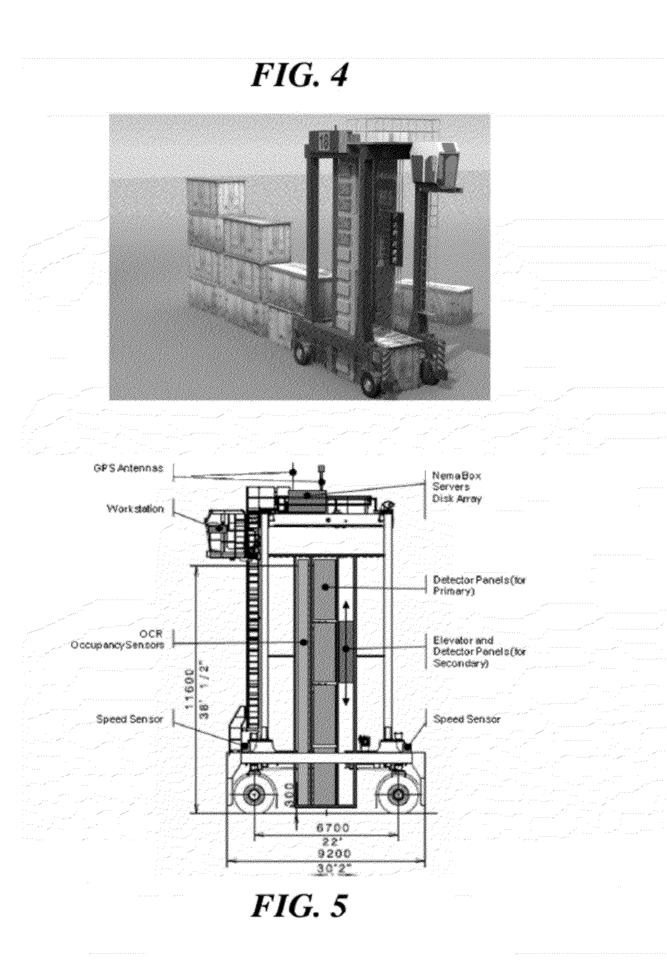

Referring to FIG. 4, an example of a straddle carrier is shown according to one embodiment of the present invention. The straddle carrier can be positioned over a stack of one or more containers and can efficiently and effectively scan the contents of each container for possible unauthorized and/or hazardous materials. FIG. 5 illustrates a side view of the straddle carrier showing the primary detector panels and the elevator and secondary detector panels.

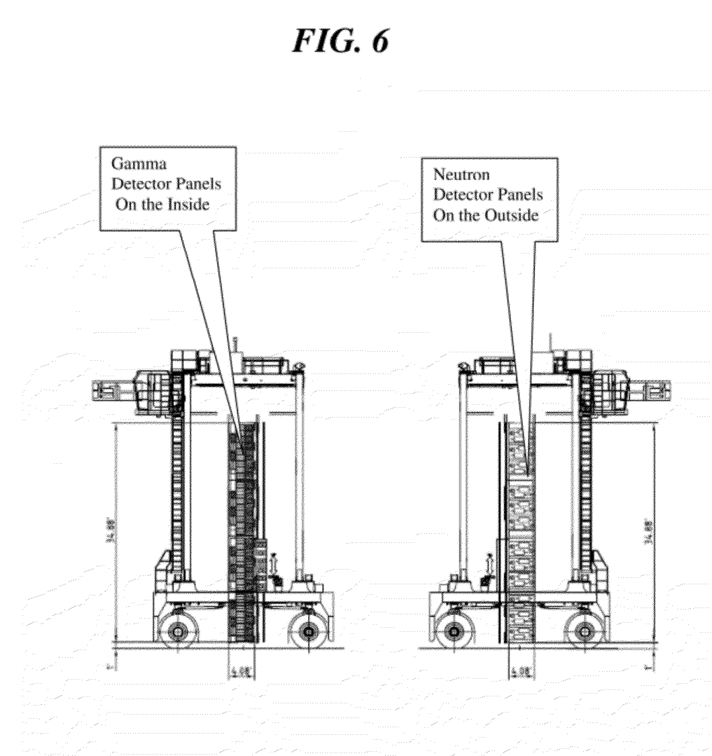

Referring to FIG. 6, gamma and neutron detector panels are shown deployed in the center of each side of the straddle carrier, with the gamma detector panels on the inside facing the container and the neutron detector panels on the outside (back-side) of the gamma detector panels.

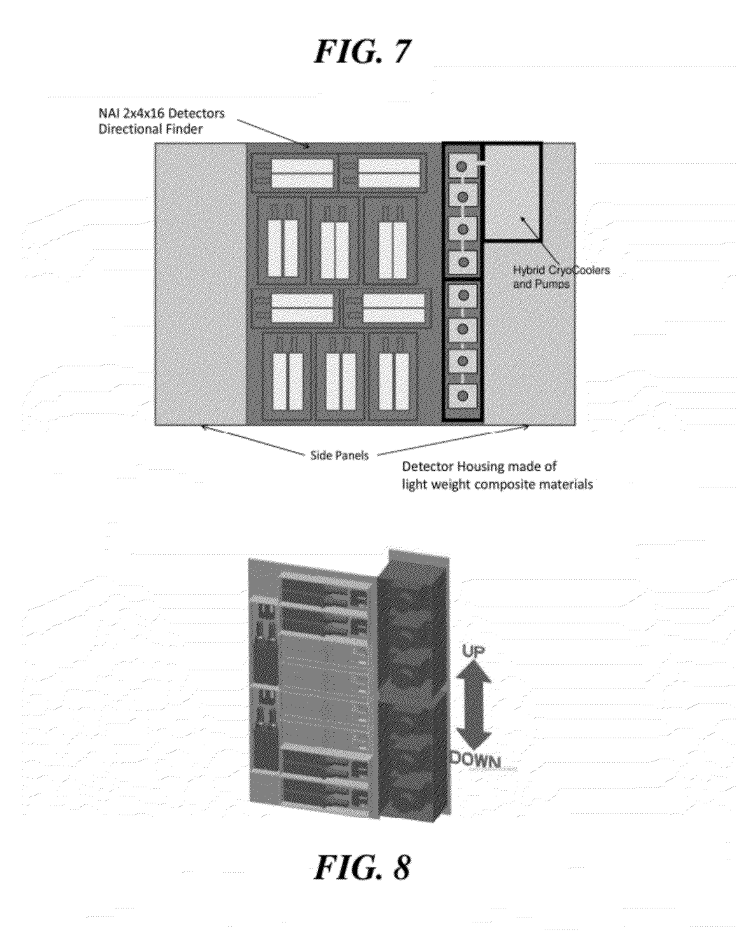

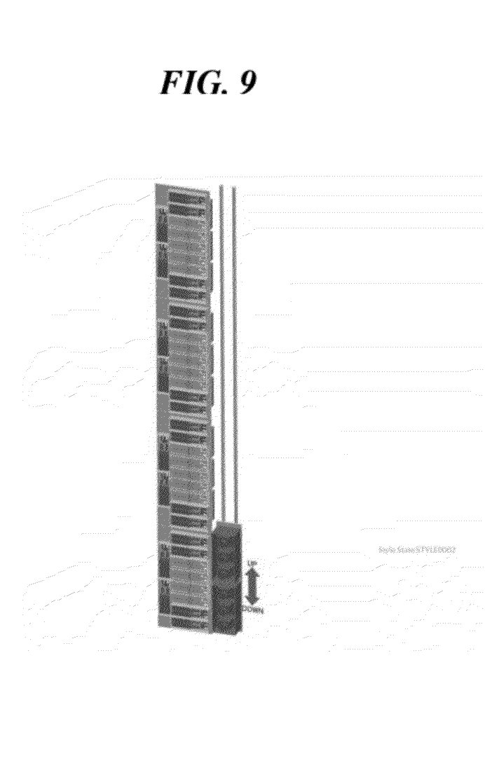

FIGS. 7 and 8 illustrate side views of a gamma scanning sensor array panel. These gamma detectors are used primarily for the detection of radiological and or fissile materials with spectral analysis capability. FIG. 9 shows a side view of multiple gamma scanning sensor array panels.

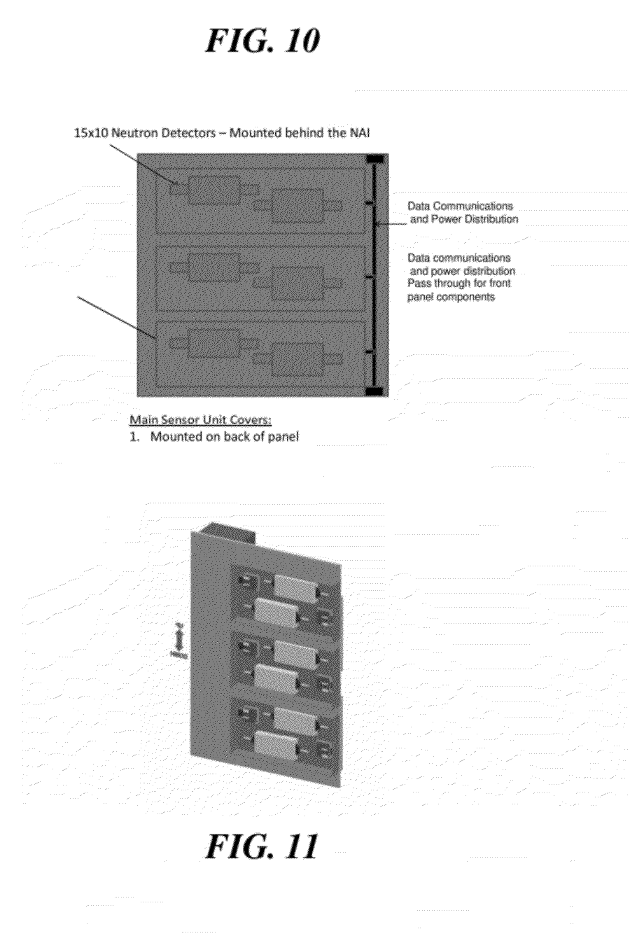

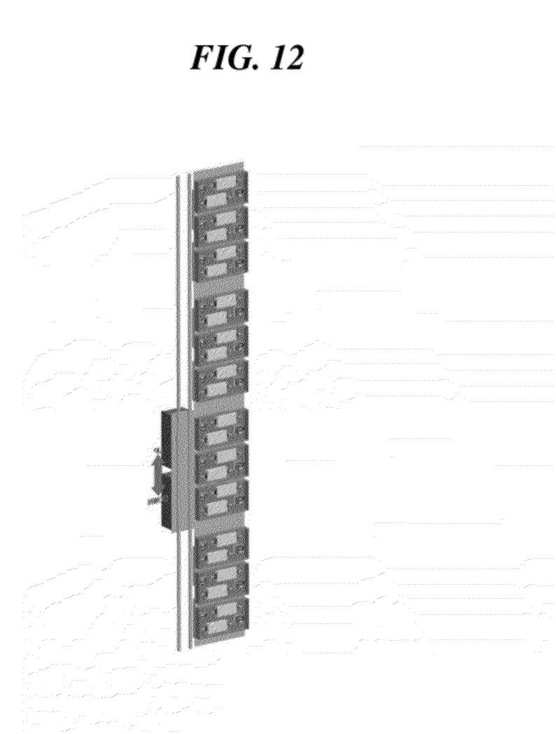

FIGS. 10 and 11 illustrate side views of a neutron scanning sensor array panel. These neutron detectors are used primarily for the detection of radiological and or fissile materials with spectral analysis capability. FIG. 12 shows a side view of multiple neutron scanning sensor array panels.

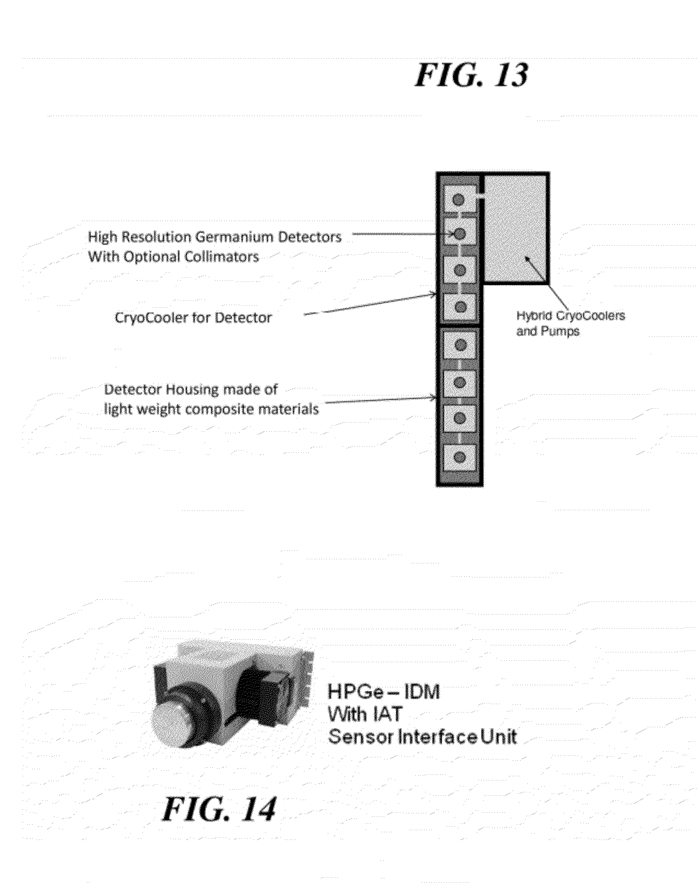

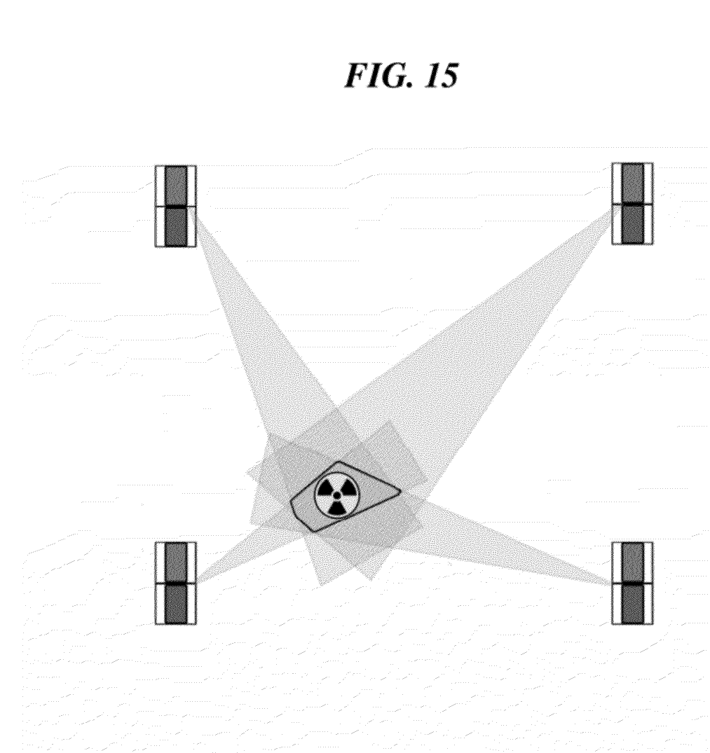

Referring to FIGS. 13 and 14, a high resolution gamma sensor system can be raised or lowered via an elevator mounted on the self propelled frame structure such as a straddle carrier. A cryocooler system is included with the high resolution gamma sensor system to reduce the sensor operational temperature to a desired level. The sensor-detector housing is made from lightweight composite materials. FIG. 14 shows a sensor module including a gamma sensor array and a sensor interface unit. Such a sensor module is commercially available from Innovative American Technology Inc., of the United States of America.

Referring to FIG. 15, an example of a radiation source location system using radiation directional finders is shown. NaI detectors, in this example, are deployed in pairs to provide directional indication of the radiation source materials detected. Such radiation directional finders enable the SCRVS to scan a stack of containers and determine which container in the stack of containers contains the detected radiological material(s). Gamma detector data is provided to a spectral analysis system that utilizes a detection process to detect the presence of radiological materials and to determine the particular container that holds such materials.

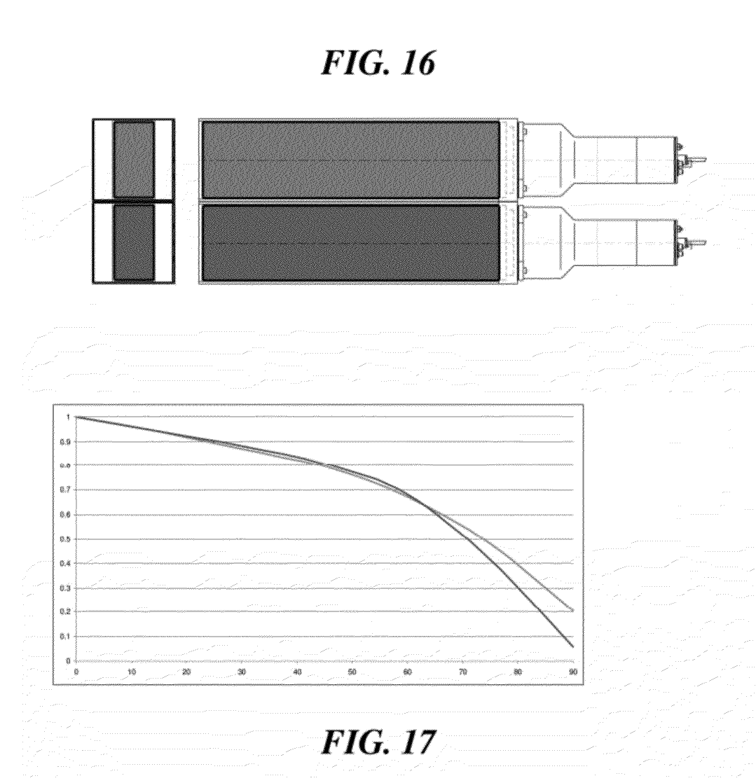

FIG. 16 shows an example of the radiation directional finder set used in FIG. 15. FIG. 17 shows test results for directional indication using a pair of directional detector set oriented relative to each other in the 0 degrees and the 90 degrees intervals. A ratio of detector counts between the pair of detectors indicates a direction of the radiation source. At about the 90 degrees mark on the horizontal X-axis of the graph, the bottom line on the graph indicates an all counts ratio from the pair of detectors. This all counts ratio includes both primary impacts of radiation particles with the individual detectors and secondary impacts (i.e., the first impact having been through the other back-to-back detector). The top line, at about the 90 degrees mark on the horizontal X-axis of the graph, indicates a photo-peak counts ratio from the pair of detectors. This photo-peak counts ratio indicates the primary impacts of radiation particles with the individual detectors. A comparison of the two ratios, and knowledge of the physical location and orientation of the pair of directional detector sets, provides an indication of the direction of a radiation source relative to the pair of directional detector sets. By utilizing multiple directional detector sets, such as shown in FIG. 15, an information processing system can utilize triangulation analysis, or other direction finding techniques, to effectively pinpoint the location of a radiation source in a detection zone as shown in FIG. 15.

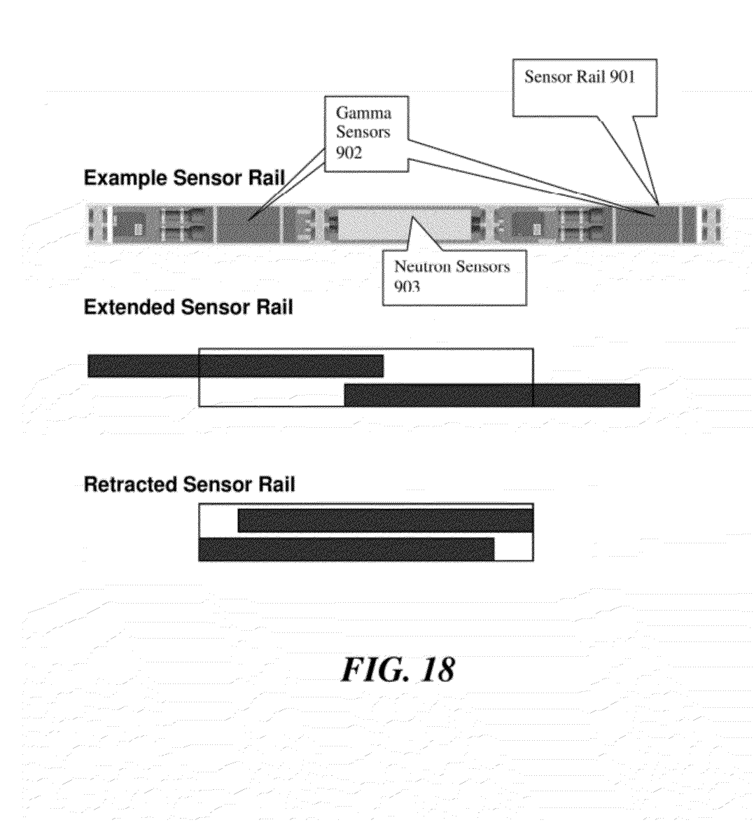

Referring to FIG. 18, an example of a sensor rail 901 for horizontal deployment on a straddle carrier or shuttle carrier or other frame structure is shown. The sensor rail 901 includes any combination of gamma detectors 902, or neutron detectors 903, or both types of detectors. Also, as illustrated in FIG. 18, the sensor rail can be extended or retracted to locate the sensors about a container or other object under inspection.

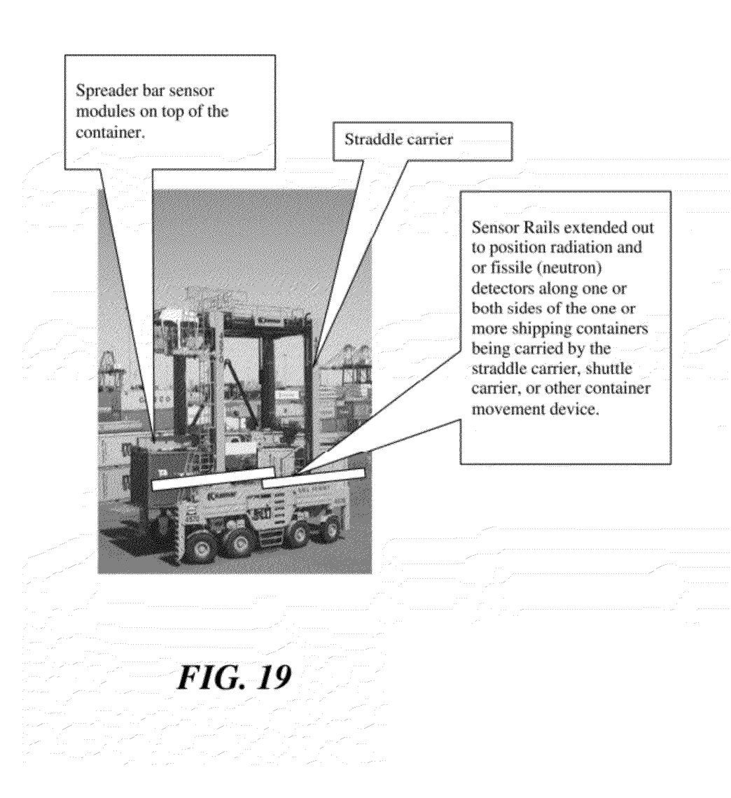

FIG. 19 shows an example of a deployment of spreader bar sensors and horizontal rail sensors on a shuttle carrier or straddle carrier or other container movement device.

By operating the system remotely, such as from a central monitoring location, a larger number of sites can be safely monitored by a limited number of supervisory personnel.

The preferred embodiments of the present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

Various embodiments of the present invention utilize gamma radiation absorption properties of NaI crystals for the directional analysis. Very often different areas of radiation detection equipment meet requirements of locating radiological source. The tasks could be different: location of leaks at nuclear power station, location of hidden dirty bomb in urban environment, or distinguish container with radiological material located in a port.

The radiation source location system, according to one embodiment of the present invention, consists of multiple detector sets placed within some distance to each other (see FIG. 15). One detector set consist of two Sodium-Iodide (NaI) detectors “sandwiched” together (see FIG. 16). When two NaI detectors are placed next to each other the closest to the radiation source detector will absorb part of gamma rays, so the second detector will have less number of gammas hitting it. By comparing the number of counts in two “sandwiched” detectors system a directional finder can determine an angle to the radiation source. The cross-section of areas determined by two or more detector sets estimates source location, such as shown in FIG. 15.

The following patents are specifically referenced and used as part of the collective teachings herein.

1) A method and system for analyzing the contents of a container as described in U.S. Pat. No. 7,005,982 entitled “Carrier Security System”, the entire teachings of which being herein incorporated by reference.

2) A method and system for analyzing the contents of a container as described in U.S. Pat. No. 7,142,109 entitled “Container Verification System for Non-Invasive Detection of Contents”, the entire teachings of which being herein incorporated by reference.

3) A method and system for analyzing the contents of a container as described in U.S. patent application Ser. No. 11/564,193 entitled “Multi-Stage System For Verification of Container Contents”, the entire teachings of which being herein incorporated by reference.

4) A method and system for analyzing the contents of a container as described in U.S. Pat. No. 7,269,527 entitled “System Integration Module for CBRNE Sensors”, the entire teachings of which being herein incorporated by reference.

### Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A system comprising one or more mobile frame structures for detecting radiation and identifying hazardous materials associated with radiation that has been detected in a detection area, comprising:
a set of distributed sensors across one or more sides of a self propelled frame structure configured as a radiation detection and isotope identification system comprising:
one or more gamma radiation detectors mounted on the inside of one or more detector panel(s) installed on the self propelled frame structure used to scan containers as the self propelled frame structure moves by one or more container stacks to detect the presence of radiological materials within at least a portion of a container in a detection area;
one or more gamma detector pair(s) mounted side by side to act as a radiological directional finder to locate the source of the radiation and the specific container that is housing the radiological materials;
one or more neutron detectors mounted on the back or outer side of one or more detector panels for the detection of fissile material(s); and
one or more high resolution gamma detector(s) mounted on an elevator, which is mounted on the self propelled frame structure, that can raise or lower the detectors to a specified position for detailed scanning of at least a portion of a container in the detection area as the self propelled frame structure moves along the stack of one or more containers to identify the isotopes that are present.
an analog signal to digital data converter;
a communications device to connect the digital data from each of the detectors to a communications network, the individual detectors being thereby network enabled radiation detectors;
a high voltage power supply to power the radiation sensor with software controls to adjust the power for calibration;
a digital data collection system, communicatively coupled with the detectors, for collection of spectral detector radiation data;
a multi-channel analyzer system, communicatively coupled with the digital data collection system, for preparing histograms of the collected radiation data;
a spectral analysis system, communicatively coupled with the multi-channel analyzer system and the digital data collection system, for receiving and analyzing the collected radiation data and the histograms to detect and to identify one or more chemical, biological, radiation, nuclear or explosives (CBRNE) materials that are present within the detection area;
a first data storage means for storing data representing CBRNE spectra for use by the spectral analysis system, where one or more spectral images stored in the first data storage unit represent each isotope, the first data storage means being communicatively coupled with the spectral analysis system;
an information processing system, communicatively coupled with the spectral analysis system, for analyzing the identified one or more CBRNE materials to determine the possible materials or goods that they represent; and
a second data storage means for storing data representing a manifest relating to the container under examination, the second data storage means being communicatively coupled with the information processing system, the information processing system further for comparing the determined possible materials or goods with a manifest relating to the container under examination to determine if there are unauthorized materials or goods contained within the container or object under examination.

2. The system of claim 1, wherein the set of distributed sensors across the one or more sides being configured with one or more gamma and neutron detectors for the detection and identification of radiation and fissile materials.

3. The system of claim 1, further comprising a wireless or wire-line communications system to transport the network enabled radiation detector data to a remotely located data collection system.

4. The system of claim 1, further comprising an integrated radiological source that may be continuously or periodically exposed to at least one radiation detector to provide a reference signal used for calibration of the radiation detector.

5. The system of claim 1, further comprising an internet connection interface communicatively coupled to the network enabled radiation detectors to provide a web-detector interface where multiple users may connect to the network enabled radiation detectors to obtain detector data.

6. The system of claim 1, wherein the radiation sensors are either continuously exposed or selectively exposed to a trace level of a radiological material to provide a reference signal for use in calibrating the radiation detector.

7. The system of claim 1, wherein the multi-channel analyzer system uses the reference signal associated with the one or more radiation sensors to adjust the collected radiation data from the one or more radiation sensors to obtain proper calibration of the collected radiation data.

8. The system of claim 1, wherein the spectral analysis system analyzes the collected radiation data and the histograms to detect radiation and to identify one or more isotopes associated with the detected radiation by using software on a computer program product.

9. The system of claim 1, wherein the system is connected to a server to enable a multiple user access.

10. The system of claim 1, wherein the communications network comprises a TCP/IP interface for communications with the network enabled radiation detectors.

11. The system of claim 1, wherein the network communications is an open interface to enable any communications capability with the network enabled radiation detectors.

12. The system of claim 1, wherein a peak detector is incorporated into the sensor to identify the detected energy range.

13. The system of claim 1, wherein a pulse shape differentiation method is employed to filter noise from a neutron detector.

14. The system of claim 1, wherein a pattern recognition systems using spectral analysis is used to identify the CBRNE materials.

15. The system of claim 1, wherein a static or dynamic background analysis and subtraction method is used to support the spectral analysis or peak detection methods used to identify the CBRNE materials.

16. The system of claim 1, wherein one or more Sensor Integration Units are used to provide the sensor interface, digital data conversion, calibration methods and sensor support.

17. The system of claim 1, wherein a micro-neutron pulse is added to the one or more gamma and/or neutron detectors to enable the identification of materials within the detection area.

18. The system of claim 1, wherein a micro-neutron pulse is added to the one or more gamma and or neutron detectors to enable the identification of shielded fissile materials within the detection area.

19. The system of claim 1, wherein the sensors are distributed across a target detection area and one or more sensors provide detection coverage for a zone area in the target detection area.

20. The system of claim 1, wherein the system is deployed for protection of any of a border, a metropolitan area, a seaport, a rail terminal, an airport, and a container transfer terminal.

21. The system of claim 1, wherein the system is deployed for truck weigh stations and other transport positions.

22. The system of claim 1, wherein the system uses both the scanning capability as the vehicle/container enters and exits a detector zone and the fixed geometry analysis as the vehicle/container is stopped in a detector zone to acquire detector data.

23. The system of claim 1, wherein the system uses the scanning capability as the vehicle/container enters and exits the detector zone to acquire detector data.

24. The system of claim 1, wherein the system uses the fixed geometry analysis as the vehicle/container is stopped in the detector zone to acquire detector data.

25. The system of claim 1, wherein the system is used to inspect any of airport baggage, railway baggage, cargo, persons, vehicles, or aircraft.

26. The system of claim 1, wherein the system is suited for use to inspect trucks and cargo at weigh stations, border crossings, roadway checkpoints, railway checkpoints and railway cargo.

27. The system of claim 1, wherein the system is used to inspect boats or vessels.

28. The system of claim 1, wherein the system is suited for use and inspection at any of military checkpoints, metropolitan area check points, metropolitan areas, at power plants, at oil refineries, at storage and distribution facilities, at buildings, and at government facilities.

29. The system of claim 1, wherein the self propelled frame structure comprises one or more of a straddle carrier, shuttle carrier, spreader bar, and forklift.

30. A radiation sensor arrangement, comprising:
one or more sensors mounted on an elevator system that can move the one or more sensors up or down a frame of a self propelled frame structure to position the sensors in optimum location for non-invasively scanning content of a container for the detection and identification of radiological or fissile materials present in the container.

31. The radiation sensor arrangement of claim 30, wherein the self propelled frame structure comprises one or more any of a straddle carrier, shuttle carrier, spreader bar, and forklift.

32. One or more frame structures comprising a set of distributed sensors across one or more sides of a self propelled frame structure such as a straddle carrier or similar cargo equipment device configured as a radiation detection, fissile material detection and or isotope identification system comprising:
one or more gamma radiation and or neutron detectors mounted on a spreader bar of a self propelled frame structure used to scan containers as the self propelled frame structure lifts one or more container(s) to detect and or identify radiological materials or fissile materials within a container; and
an analog signal to digital data converter;
a communications device to connect the digital data to a communications network;
a high voltage power supply to power the radiation sensor with software controls to adjust the power for calibration;
a digital data collection system, communicatively coupled with the detectors, for collection of the spectral detector data;
a multi-channel analyzer system, communicatively coupled with the digital data collection system, for preparing histograms of the collected radiation data;
a spectral analysis system, communicatively coupled with the multi-channel analyzer system and the digital data collection system, for receiving and analyzing the collected data and the histograms to detect and to identify one or more radiation and or nuclear materials that are present within the detection area;
a first data storage means for storing data representing gamma and/or fissile spectra for use by the spectral analysis system, where one or more spectral images stored in the first data storage unit represent each isotope, the first data storage means being communicatively coupled with the spectral analysis system;
an information processing system, communicatively coupled with the spectral analysis system, for analyzing the identified one or more gamma and or fissile materials to determine the possible materials or goods that they represent; and
a second data storage means for storing data representing a manifest relating to the container or object under examination, the second data storage means being communicatively coupled with the information processing system, the information processing system further for comparing the determined possible materials or goods with a manifest relating to the container or object under examination to determine if there are unauthorized materials or goods contained within the container or object under examination.

33. One or more frame structures comprising a set of distributed sensors across one or more sides of a straddle carrier configured as a radiation detection, fissile material detection, and/or isotope identification system, comprising:
one or more gamma and or neutron radiation detector modules mounted in one or more moveable horizontal rails on the side of the straddle carrier and used to scan containers as the straddle carrier lifts one or more containers to detect and or identify radiological materials within a container; and
an analog signal to digital data converter;
a communications device to connect the digital data to a communications network;
a high voltage power supply to power the radiation sensor with software controls to adjust the power for calibration;
a digital data collection system, communicatively coupled with the detectors, for collection of the spectral detector data;
a multi-channel analyzer system, communicatively coupled with the digital data collection system, for preparing histograms of the collected radiation data;
a spectral analysis system, communicatively coupled with the multi-channel analyzer system and the digital data collection system, for receiving and analyzing the collected data and the histograms to detect and to identify one or more radiation and or nuclear materials that are present within a detection area;
a first data storage means for storing data representing radiation and or fissile counts or spectra for use by the spectral analysis system, where one or more spectral images stored in the first data storage unit represent each isotope, the first data storage means being communicatively coupled with the spectral analysis system;
an information processing system, communicatively coupled with the spectral analysis system, for analyzing the identified one or more gamma or fissile materials to determine the possible materials or goods that they represent; and
a second data storage means for storing data representing a manifest relating to the container or object under examination, the second data storage means being communicatively coupled with the information processing system, the information processing system further for comparing the determined possible materials or goods with a manifest relating to the container or object under examination to determine if there are unauthorized materials or goods contained within the container or object under examination.

34. The one or more frame structures of claim 33, wherein the one or more horizontal rails can be stored in a retracted position or extended out to position the detectors across the side of the container.

35. The one or more frame structures of claims 33, wherein the gamma detectors are positioned to face the side of the container.

36. The one or more frame structures of claims 33, wherein the detectors are shielded from background gamma and or fissile detection.
